(19) United States
(12) Patent Application Publication
(10) Pub. No.: US 2013/0086323 A1
(43) Pub. Date: Apr. 4, 2013

(54) EFFICIENT CACHE MANAGEMENT IN A CLUSTER

(71) Applicant: Hareesh S. Kadlabalu, Plainview, NY (US)

(72) Inventor: Hareesh S. Kadlabalu, Plainview, NY (US)

(73) Assignee: ORACLE INTERNATIONAL CORPORATION, Redwood Shores, CA (US)

(21) Appl. No.: 13/488,184

(22) Filed: Jun. 4, 2012

Related U.S. Application Data
(60) Provisional application No. 61/541,613, filed on Sep. 30, 2011.
(60) Provisional application No. 61/578,679, filed on Dec. 21, 2011.

(51) Int. Cl. G06F 12/08

(52) U.S. Cl. 711/119; 711/E12.017

(57) ABSTRACT

A content management system has at least two content server computers, a cache memory corresponding to each content server, the cache memory having a page cache to store cache objects for pages displayed by the content server, a dependency cache to store dependency information for the cache objects, and a notifier cache to replicate changes in dependency information to other caches.

### RELATED APPLICATIONS

This application is a continuation of and claims priority to U.S. Provisional Patent Application No. 61/541,613, filed Sep. 30, 2011, and U.S. Provisional Patent Application No. 61/578,679, filed Dec. 21, 2011.

### BACKGROUND

Content management systems allow developers to publish and refresh content served up to users through online sites throughout the Internet. The content of these sites changes rapidly and developers publish and update the sites constantly. One should note that the term ‘site’ as used here includes Internet sites, portals, sites accessible to the general public, password-protected sites, and exclusive sites operating within a private domain, and others. While the discussion here focuses on the improvements in the context of a content management system, the improvements discussed below apply to any system that manages information that is rapidly and frequently updated across several nodes.

Typically, a content management system has a shared, centralized repository. Each layer of the system including content servers as well as local servers may have local caches. Local caches allow sites to display frequently accessed items quickly and without having to query the central repository. Management of these caches and ensuring that the content of the caches remain up to date and valid may consume considerable system resources.

Without cache management, sites may display information that has expired or changed with no means to update or mark the information as invalid. Cache management generally involves updates sent between the cache and the central repository to ensure that the information stored in each reflects the information stored in the others. This allows the sites to rely on the data in the caches and display them accurately. Identification of ‘bad’ data, data that has expired or otherwise become invalid, results from this updating process.

### BRIEF DESCRIPTION OF THE DRAWINGS

FIG. 1 shows an example of a content management system.

FIG. 2 shows an embodiment of a distributed cache architecture.

FIG. 3 shows a flowchart of an embodiment of a method of invalidating assets in a cache.

FIG. 4 shows a flowchart of an embodiment of a method of invalidating pages with invalid assets in a cache.

FIG. 5 shows an embodiment of a local cache structure.

### DETAILED DESCRIPTION OF THE EMBODIMENTS

The following discussion may use examples to assist with understanding of the structure and operation of the embodiments. These examples are not intended to limit the scope of the claims in any way and no such interpretation should be made.

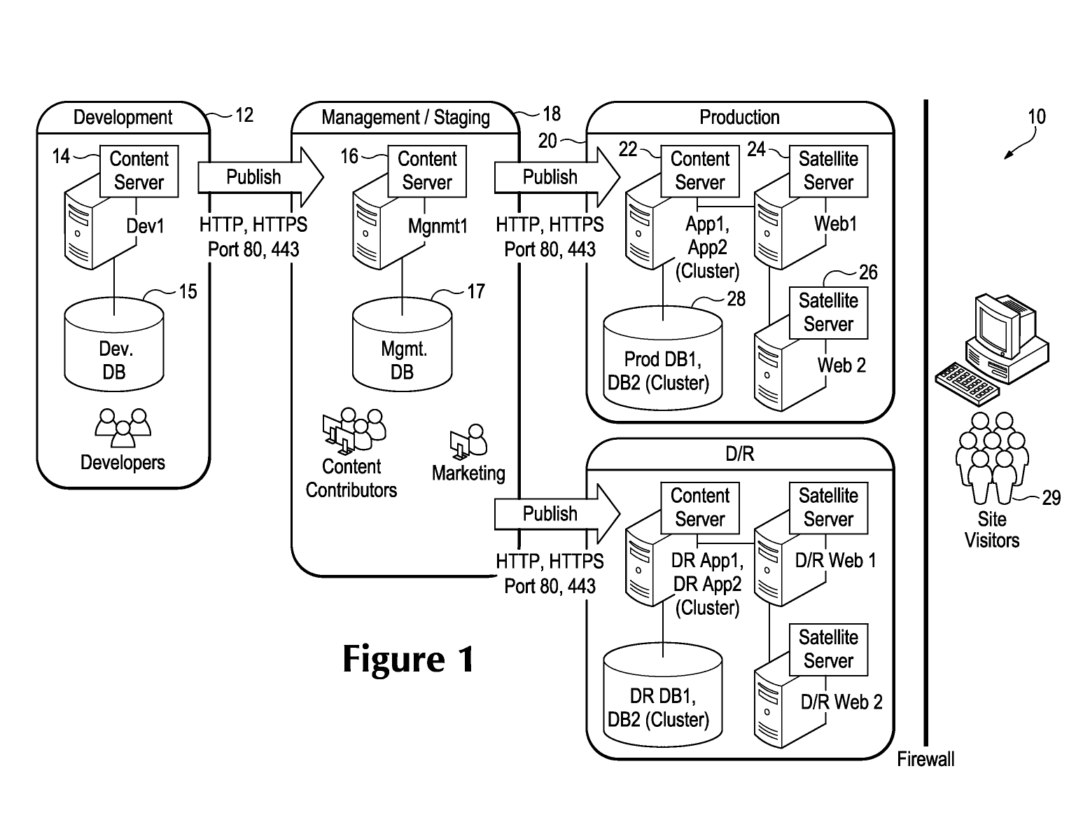

FIG. 1 shows an example of a content management system employing a distributed cache system. As the term used here, a ‘distributed cache’ means a cache system consisting of multiple local caches attached to nodes in the system. The nodes may consist of content servers used for development, content servers used for publication and satellite servers used for remote access by visitors. Satellite Servers are edge caching systems, for the purposes of caching they are just other nodes with their own local cache.

A content management system that has changing content will publish the changes frequently, and this discussion may refer to this as dynamic publishing. For example, a content management system may consist of a web site that sells products. The web site may include several different web pages, with some pages possibly being populated and displayed in real-time. Products for sale may reside in several different web pages on the site. For example, a clothing retailer may display an item, which may also be referred to as an asset or cache object, consisting of a pair of women's running shoes on a page for women's clothing and shoes, a page for athletic clothing and gear, and a page for all shoes.

The pair of shoes represents an asset. Assets may include any items used to populate web pages. Examples may include photos, texts, graphics, etc. An asset may have several different attributes associated with it. In the case of a product, such as the example of the shoes, these may include an image of the shoes, their price, the brand name, etc. In a typical system, if one of those attributes changes, the pages relating to that product may be invalidated. The invalidation may occur at the page level, but it may occur at any cached object's level. The amount of data that needs caching and the frequency of updates increases the database access time, load on other parts of the architecture and the time it takes to remove outdated information. The presence of outdated information renders the system less efficient and reduces customer satisfaction.

The users or visitors to a particular web site will see the production side of the system. As shown in FIG. 1, it is apparent that the content management system 10 has several other components. A development system 12 has a content server 14 that is used to publish changes to assets in the system. The content server has a local cache that stores frequently accessed assets from the database 15. The management and staging system 18 also has a content server 16 used to publish changes to the production system 20 and a database 17. The production system 20 has content servers such as 22 and satellite servers such as 24 and 26. The users or visitors 29 will typically access the pages of the website through the satellite servers. Each of these servers has local caches, linked together in a unique fashion, acting as a distributed cache.

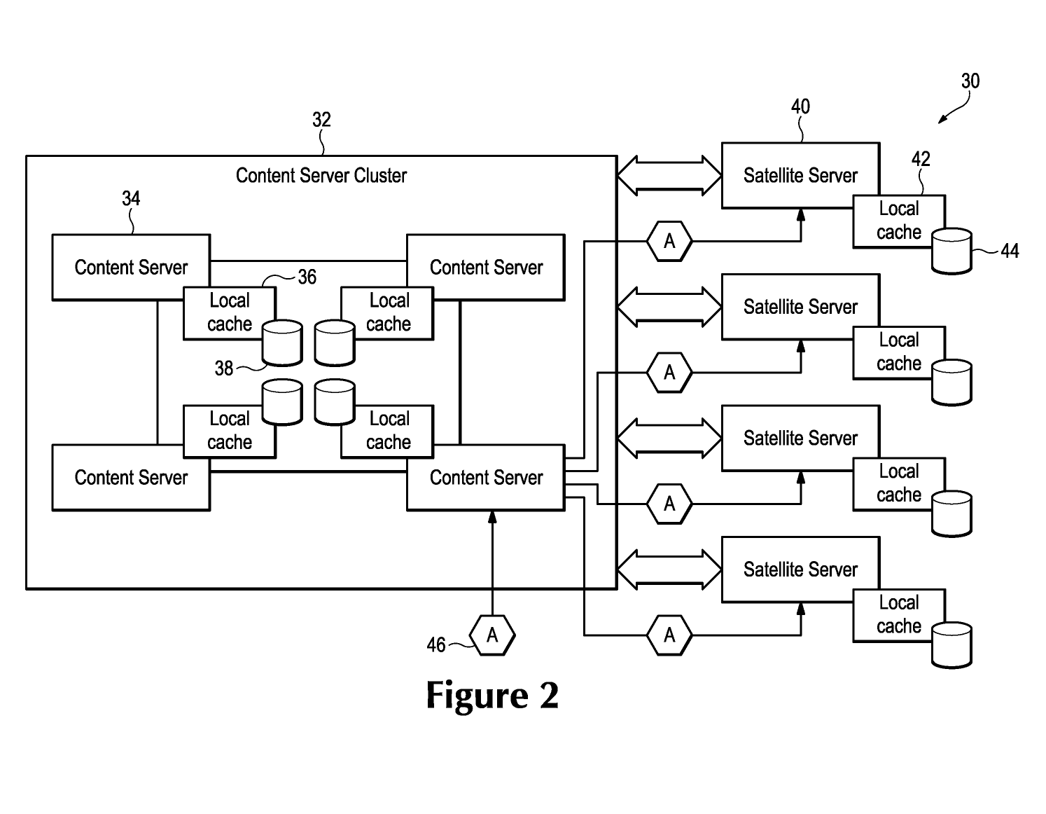

An embodiment of a distributed cache system is shown in FIG. 2. Local caches are populated based on usage patterns and configuration and the amount of cache is typically limited by available memory or other resources. However each of these of the caches do not need to have a view of the entire cache for the system as a whole to still function efficiently. Changes are broadcast from one local cache to the other nodes, where a node consists of a server and its local cache. The server may consist of a content server or a satellite server. A content server consists of a server upon which developers generate and develop content in the form of assets. A satellite server receives cache updates from content servers.

The system architecture may take many forms. In the system embodiment 30 of FIG. 2, the content servers such as 34 may reside in a content server cluster 32. Each content server such as 34 has a local cache such as 36. The local cache allows repeatedly accessed data to be rapidly accessed in memory, avoiding repeated calls to the data source 38, which may consist of a database or a network accessed source.

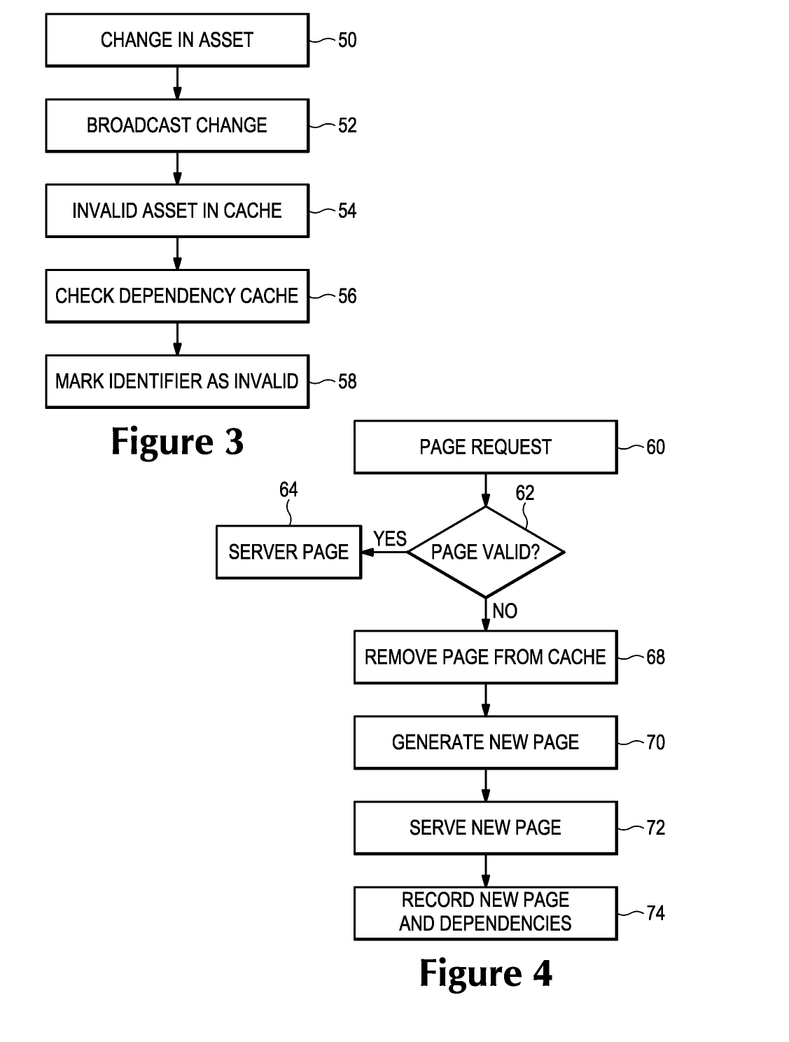

The system also typically includes at least one satellite server such as 40. Similar to the content servers, each of the satellite servers such as 40 has a local cache 42 and a data source 44. As mentioned above, when an attribute of an asset such as “A” gets updated at a content server the content server will propagate the change out to the satellite servers as well as its own local cache. A performance advantage of the current system results from the nature of the propagation, discussed in more detail later. When an attribute of the asset changes, the change triggers several events. FIG. 3 shows a flowchart of an embodiment of a method of updating the distributed cache.

The change needs to propagate to the other caches in the system so they have the updated information. Further, the attribute that changes may have associated dependencies that will also change. For example, the shoes used above as an example may have a price change resulting from the manufacturer raising or lowering the price for all of their products. In a portion of the cache, discussed in more detail later, dependencies between the different attributes of the asset are tracked. A dependency is a list of keys associated with this asset, in this case, the manufacturer.

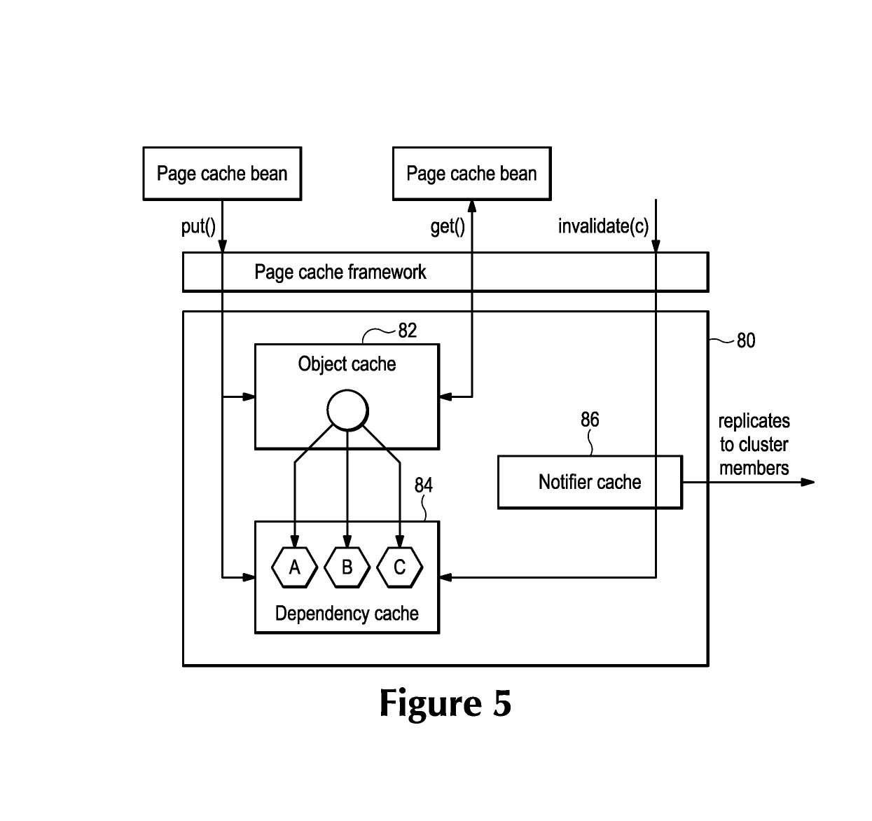

When the price change for the asset occurs, the system checks the dependency portion of the cache and includes the dependencies associated with the asset and invalidates those as well. These dependencies may take the form of cache objects consisting of other web pages that include that asset on its pages. A dependency is an object that is stored in the dependency cache. As shown in FIG. 5, an ‘object cache’ maintains a link to a set of such dependencies. Such a link is based on an identifier of the dependency cache, a String value that is kept as part of the ‘object cache.’

In FIG. 3, a change in an asset occurs at 50. The change will occur at a content server due to a change published by a developer or other administrator in the system. At 52, the content server broadcasts the change to the other local caches in the distributed cache. In addition, the content server will also invalidate the asset in its own cache at 54. One should note that these processes may occur simultaneously, or in any order, no particular order should be implied from this discussion.

The receiving nodes receive the broadcast change and check their own dependency caches at 56. If the asset identifier exists in the dependency cache, the node marks the identifier as invalid at 58. The identifier may include a flag bit associated with the identifier, where the flag bit is set to 0 or 1 to mark the identifier as valid or invalid. In one embodiment, the flag consists of a Boolean flag with a true/false. The asset identifies that exist in the dependency cache are also versioned, with version numbers assigned at the time of their creation in that cache. Links maintained to these identifiers in Object Cache also contain version identifiers. This technique eliminates any race condition that may exist between successive invalidation operations and additions to the dependency cache.

The performance advantage results from the node not evaluating the pages with invalid assets until the pages having invalidated assets are requested. Because the invalidated asset is no longer available to pages that reference the asset, the pages themselves are invalidated. FIG. 4 shows an embodiment of a process for handling requests for pages. At 60, a node receives a request for a page. The node checks the dependency cache to determine if the page has any invalid assets, rendering the page invalid, at 62. If the page has valid assets, the system serves the page to the web site visitor at 64. If the page has invalid assets, meaning the page is invalid, the page is removed from the cache at 68.

One should note that a page being marked invalid only results in the page being regenerated with new information from the data store at 70 when a request for the page is received. Otherwise the page just remains having assets marked invalid. Once the page is regenerated, the system then serves up the new page at 72. In order to update the dependency cache, the page is stored in the object cache and its dependencies are updated by storing them in the dependency cache at 74. The page then remains valid until assets to which the page links are invalidated or the page expires.

Two different actions occur in this process. First, invalidation of objects results from user edits, new information published, or some other action. Second, a read occurs from a cache for cached objections. In the invalidation occurrence, no cached data is actually removed. Only the dependency entry is marked as invalid. The cache object retains this dependency, so it still exists in the cache. When a cache read occurs, the system determines that it is no longer valid, and therefore no reason for it to reside in the cache. The system then removes the invalid object upon a read. It may also remove the object upon a cleanup process that acts as a scavenger. Removal may consist of emptying a cell in a hash table like structure. Another embodiment may have the system ignore or overwrite the invalidity to remove it from consideration by the system.

These pages are invalidated upon the subsequent access and marked as such. In other words, upon the invalidation of dependency, a number of pages may become candidates for invalidation but the system does not know or care which ones they are. The system simply does not know. It is computed at the subsequent access. This provides a significant gain in performance, the system does not have to spider through pages, which could be millions in number, to check if they contain an invalid link and then mark them as such.

FIG. 5 shows an embodiment of a cache structure that enables the above processes. The local cache 80 has three sub-caches or partitions of the cache. These include an object cache 82, from which the pages are served, the dependency cache 84 and a notifier cache 86. When a page is requested, the object cache 82 checks the dependency cache 84 to check for invalid assets. When a change invalidates the asset, the notifier cache 86 propagates the change as necessary to other cluster members or to the satellite server caches. It also updates the dependency cache.

Updating the caches may occur between the content servers and other content servers as well as between content servers and the satellite servers. The content servers use the notifier cache to update the other content servers. The pages and dependencies are not updated, just notifications of invalidation. As mentioned above, invalidation simply removes the dependency, making the pages invalid. Typically, invalid pages are removed from the cache when a read operation occurs. Alternatively, a background operation may run periodically to remove them.

An update between the content server and a satellite server operates a differently. The satellite server reads the page data in a typical read operation, but receives the dependencies from a special header. The invalidation process may be staggered, allowing for page regeneration and double buffered caching. Page regeneration may involve crawling to regenerate pages during publishing sessions.

Double buffered caching may involve using the content server and satellite server caches in tandem on live web sites. This ensures that pages are always kept in cache, on either the content server or satellite server, to protect the content server from overload from page requests. This also prevents the web site from displaying blank pages or broken links. The double buffered caching occurs by keeping the remote satellite server in communication with the content server via HTTP requests. The satellite server will still read page data via HTTP requests and caches in the usual way. Page data now include dependency information, which may take the form of a comma-separated list of asset identifiers that is also streamed to remote satellite servers.

For the remote satellite servers, the page propagation enables the content server nodes and the satellite server nodes to host the same pages without each node having to regenerate the pages. Instead of referring to the database to regenerate pages, nodes receive newly generated and regenerated pages into their local caches from the nodes on which the pages were regenerated and cached. Caching the pages may trigger their propagation.

In this manner, nodes can retain cache on the disk and recover from failure. The decentralized architecture prevents bottlenecks and page propagation eliminates the need to regenerates pages, while page regeneration is background mode enables remote satellite servers to continue serving pages while the system regenerates pages.

Thus, although there has been described to this point a particular embodiment of a method and system to monitor database performance, it is not intended that such specific references be considered as limitations upon the scope of this invention except in-so-far as set forth in the following claims.

What is claimed is:

1. A content management system, comprising:
at least two content server computers;
a cache memory corresponding to each content server, the cache memory comprising:
a page cache to store cache objects for pages displayed by the content server;
a dependency cache to store dependency information for the cache objects; and
a notifier cache to replicate changes in dependency information to other caches.

2. The content management system of claim 1, further comprising at least one satellite server, the satellite server having a local cache.

3. The content management system of claim 1, wherein the cache memories corresponding to the content server computers are clustered.

4. The content management system of claim 1, wherein the page cache, dependency cache and notifier caches comprise partitions of the cache memory.

5. A computer-implemented method of managing a distributed memory system, comprising:
maintaining at least two cache memories, each cache memory containing at least one cache object and a dependency associated with the cache object;
receiving, at one of the cache memories updated information with regard to a cache object in another of the cache memories;
invalidating the cache object in the one cache memory; and
using the dependency to determine if other cache objects in the one memory are to be invalidated in a lazy manner, at the time of their subsequent access.

6. The method of claim 5 wherein the cache memories comprise a local cache of a content server and a local cache of a satellite server.

7. The method of claim 6, wherein the cache memories employ double buffering where a web page resides in both memories simultaneously.

8. The method of claim 5, further comprising:
receiving a request for a web page; and
determining if the web page has any invalid cache objects.

9. The method of claim 8, wherein determining if the web page has any invalid cache objects comprises checking a flag associated with the cache objects.

10. The method of claim 9, further comprising removing the web page from the cache if the page has invalid cache objects.

11. The method of claim 10, further comprising:
generating a new page;
serving the new page;
recording the new page in a page cache; and
recording dependencies associated with the new page in a dependency cache.

12. One or more non-transitory computer-readable media storing instructions that, when executed by a processor, cause the processor to perform a method comprising:
maintaining at least two cache memories, each cache memory containing at least one cache object and a dependency associated with the cache object;
receiving, at one of the cache memories updated information with regard to a cache object in another of the cache memories;
invalidating the cache object in the one cache memory; and
using the dependency to determine if other cache objects in the one memory are to be invalidated in a lazy manner, at the time of their subsequent access.

13. The one or more non-transitory computer-readable media of claim 12, wherein the cache memories comprise a local cache of a content server and a local cache of a satellite server.

14. The one or more non-transitory computer-readable media of claim 12, wherein the cache memories employ double buffering where a web page resides in both memories simultaneously.

15. The one or more non-transitory computer-readable media of claim 12, further comprising:
receiving a request for a web page; and
determining if the web page has any invalid cache objects.

16. The one or more non-transitory computer-readable media of claim 12, wherein determining if the web page has any invalid cache objects comprises checking a flag associated with the cache objects.

17. The one or more non-transitory computer-readable media of claim 16, further comprising removing the web page from the cache if the page has invalid cache objects.
